(19) United States
(12) Patent Application Publication
(10) Pub. No.: US 2003/0047538 A1
(43) Pub. Date: Mar. 13, 2003

(54) Laser etching indicia apparatus

(76) Inventor: Paul Trpkovski, Loganville, WI (US)

Correspondence Address: Allen W. Groenke, Fredrikson & Byron, P.A., 900 Second Avenue South, 1100 International Centre, Minneapolis, MN, 55402, US

(21) Appl. No.: 10/084,113

(22) Filed: Feb. 25, 2002

Related U.S. Application Data
(60) Provisional application No. 60/322,558, filed on Sep. 12, 2001.

(51) Int. Cl. C23F 1/00; C03C 15/00

(52) U.S. Cl. 216/84; 216/94

(57) ABSTRACT

An apparatus is provided for the automatic placement of indicia, such as logo, and manufacturer and material information, on planar workpieces, such as glass. This apparatus is suitable for line processing. When the workpiece arrives at the apparatus, a shuttle, housing a laser, moves over the workpiece to find the edges of the workpiece using an optical sensor also within the shuttle. The shuttle may then move to the interior of the workpiece according to a suitable offset as instructed by the software. When the shuttle is in position, the laser may impart one or more indicia to the workpiece at an orientation instructed by a software module. The indicia may consist, for example, of a graphics file, which may be made up of another graphics file such as a logo, and textual information regarding the workpiece properties, place or date of manufacture, or the like.

### CROSS-REFERENCE TO RELATED APPLICATIONS

This application claims the benefit for priority of U.S. Provisional Application Serial No. 60/322,558, filed Sep. 12, 2001, which is incorporated herein by reference in its entirety.

### TECHNICAL FIELD

The present invention relates to methods and apparatus for inscribing or etching indicia, such as manufacturing or descriptive information, onto planar materials such as glass, particularly, to the use of a laser to effect etching in an automated fashion.

### BACKGROUND

It is commonly desirable in manufacturing, and particularly in the manufacture and use of flat glass products, to etch certain information onto a product. In the field of glass manufacture and assembly, for example, it may be desirable to etch information into a glass product such as information about the manufacturer or reseller of the glass, whether the glass is tempered, the place and time of manufacture, plant number, the property or types of coatings or laminates on the glass, its acoustic or ballistic properties, a serial or model number, and the like. Much of this information is likely to be useful to downstream users of the glass, such as purchasers, contractors, or installers. These indicia are often placed in what will become the bottom corner of the glass according to the orientation of the indicia.

The information imparted may be the same between different workpieces, such as the place of manufacture, or may vary between different pieces. The indicia may include safety or light-filtering ratings and certification information. In addition, the National Fenestration Rating Council (NFRC) has developed a window energy rating system for finished window products, which is to be placed on a NFRC label, allowing purchasers of window products to accurately compare different products from different manufacturers according to data pertaining a standardized size. The NFRC label lists the manufacturer, describes the product, provides a source for additional information, and includes ratings for one or more energy performance characteristics, as tested for a specified product type by an accredited testing laboratory or certification and inspection agency. For example, the NFRC Label may include information on U-factor (which pertains to how well a product prevents heat from escaping); Solar Heat Gain Coeffecient (SHGC) (showing how well a product blocks heat caused by sunlight); Visible Transmittance (VT) (which measures how much visible light passes through a product), and Air Leakage (AL), measured in cubic feet of air for a given area. The NFRC label is to appear on all products certified to the NFRC standards, and on all window, door, and skylight products which are part of certain energy-conservation certification programs. In the future, the NFRC label may contain rating and certification information regarding condensation resistance, long-term energy performance, ultraviolet light protection, or other information. Other information that may be useful to impart onto glass, particularly insulating glass units, are the class of the ASTM E 773/E 774 specification (e.g., class CBA) for seal durability, or trade group or certification mark information, for example, Insulating Glass Certification Council (IGCC) or Sealed Insulating Glass Manufacturers Association (SIGMA) ratings, approvals, or values.

A workpiece indicia, particularly one for glass, typically has two primary components, a central logo or symbol, e.g, pertaining to a manufacturer or reseller; and perimeter writing. The perimeter writing will typically wrap around the area of the logo, for example, on two sides closest the sides of the workpiece.

In the past, indicia such as safety ratings or manufacturer information, in the case of glass, was effected by using a stencil, manually placed in the desired location on the glass. The glass would typically be placed parallel to the ground, for example, flat on a work table. A sandblaster was then used to etch the glass through the stencil, and the areas left exposed by the stencil were imparted with the desired indicia. One drawback of this system was the fact that the manual placement of the stencil meant that the process was not well-suited to production line processes—the glass would have to typically be removed from a production line, etched, and then returned to the line. Furthermore, the use of sand can leave particulate residue on the glass that has to be removed. Most significantly, the use of stencils does not facilitate the rapid interchange of logos with other indicia information such as perimeter writing. Not only is it time consuming to switch between stencils, but the making of new stencils involves costs and delays. Accordingly, for practical purposes etching is limited to stencils on hand. Finally, in addition to all of these limitations, only a limited precision of graphics is possible with stencils; so, for example, type size must be larger than the smallest type that is generally readable with the unaided eye.

More recently, lasers have proven to provide a means of etching materials such as glass without some of the drawbacks of sand etching. For example, laser etching apparatuses have been used in a manner which is, in essence, a high-tech version of the sandblasting technique discussed above. For example, laser etchers have been used, by the assignee of the instant application, in connection with a fixed pedestal and fixed laser to etch glass. An operator would position the glass relative to this fixed laser, and operate a foot pedal to effect the etch, i.e., activate the laser. However, the workpiece relative to the laser device must be manually placed, a process which requires human intervention, and is also subject to human error. For example, if indicia is placed by “eyeballing,” or estimating by a human operator, the indicia may not prove to be in the least conspicuous or otherwise desirable location on the planar surface. For example, in the case of a triangular pane of glass, a human operator may place the indicia in a location that is not properly centered according to a standardized location in the corner of the glass. The position is not easily repeatable over different panes, and is subject to user interpretation and user error. If a precise measurement is to be used instead of eyeballing the indicia location, this will prove to be a very time-consuming process, particularly in the event that a number of different shapes are being etched in succession. If a reverse image, i.e., one that is oriented to be readable from the non-etched side of the glass, a computer file that is provided to the laser etcher may be “flipped” by the operator so as to present data representing the reversed image to the laser. Laser images can be changed instantaneously by sending the desired graphics in a data file useable by the laser device. An improvement in this system has been in use by the assignee of the instant application for approximately 18 months, in which a laser-imparting device is movably placed on a vertical beam; the laser being capable of moving up and down along the linear beam. In operation, a pane of glass may be moved along a sliding surface, such as an assembly line. The workpiece may then be stopped by, or in reference to, a reference point, especially a stop arm, which supplies a zero point from which the indicia location could be established. Notably, however, this device does not eliminate guesswork on the part of the operator. While the horizontal, or “x axis” location of the laser is fixed relative to the stop arm, operator judgment is called into play in the vertical “y axis” positioning of the laser etcher. Additionally, in operation the operator is required to select a particular logo file that is to be etched, appropriate to the workpiece that the operator is presented with. This provides another opportunity for user error which can cause waste in production, quality variations, or non-standard output. Because the optical sensor for the edge of the glass is at a fixed location relative to the bottom of the glass, this method is only suitable for rectangular workpieces—if an edge that is not substantially vertical is presented to the optical sensor, the indicia placement will be further from the edge than desired, as it must be assumed that the entire edge of the glass is the same horizontal distance from the position of the optical sensor. Furthermore, because the system relies on user placement, it is only suitable for large-production runs of identical workpieces, where a standard location may be chosen to reduce variability and operator decision-making, which leads to non-standard output. Existing laser marking devices are not well-suited to variable positioning of the mark to be imparted to a workpiece. For example, a commonly used laser marking device is commonly used with a fixed mounting stand designed to hold the laser device. While certain laser marking devices provide for a certain offset from the center of the marking target area, this moves the marked image by only a few centimeters at most, even for lenses with relatively long focal lengths, such as 370 mm. In fact, the entire marking field, even with this long focal length, is about 10 centimeters for laser marking devices presently in use. Naturally, any movement of an indicia by the laser device itself must take place entirely within this field, thus providing for only limited movement of the indicia relative to the laser device itself. Laser marking devices sometimes are supplied with control software that can be used to load computer files to the laser device to be implemented on the workpiece. The computer files typically contain image data readable by a computer, which is then implemented in the laser device to reproduce the desired image. Certain laser marking devices are designed to be compatible with computer cards to provide, e.g., a fiber-optic control link between a computer and the laser marker. Laser markers have also been designed that, in conjunction with computer software, provide for synchronization with automated production processes. However, because the laser marking devices are often used with fixed, stationary mounting stands, the opportunity for use with automated processes is limited to moving workpieces under the laser marker mounted on the fixed stand, for example, on a conveyor belt. Because the workpieces must, unless manually placed, move laterally under the laser marker along one dimension, which may be termed the “x” dimension. the position of the indicia for these automatically-positioned workpieces can only be varied along this single “x” dimension, except for a few centimeters along the second, or “y” axis.

It would be desirable to provide a system or apparatus in which surface-etching of work pieces is effected quickly and accurately, while being less subject to human error in indicia placement. Preferably, such a system would be versatile and flexible, so that changes in the shape of the work piece would not require resetting of the machinery or control of a processing line.

### SUMMARY OF THE INVENTION

The present invention provides for an automated surface etcher, capable of inscribing a desired figure, textual information, or a combination thereof onto a planar surface such as glass. The present invention is preferably integrated with a processing line, such as a glass coating or other processing line. While “glass” is referred to generally herein as a subject workpiece, it will be appreciated by those skilled in the art that a variety of workpiece materials may be used with the present invention, accordingly, references to glass may be taken to refer to planar workpieces generally.

In a preferred embodiment of the present invention, a mode of operation of a laser etching device may be provided by which a plurality of operating modes are available for selection by a operator or line manager or other person charged with processing line configuration. For example, a first mode could be supplied which may be characterized a manual mode, in which processing is effected according to maximizing efficiency in making multiple identically-marked windows for volume runs. The operators simply selects the indicia corner (e.g., upper left, upper right), indicia orientation, and the indicia, i.e., the computer file containing the graphics information that will be imparted to the planar material by the laser. While the laser-imparted image may be referred to generally as a “logo,” other graphic and text information, such as perimeter writing, may be imparted to the planar material as well, and sent to the laser device in a unitary complete file. All of this information together may be referred to hereafter as the “logo”. For example, in imparting information onto a pane of glass, the logo may include manufacturer information, and other information such as the type of glass, the coatings or films applied to the glass, whether the glass is tempered, a window manufacturer for which the glass or insulating glass unit is being produced, applicable patent marking or trademark registration designations, certification designations, and light filtering and insulation performance data, and the like.

A complementary mode to the manual mode may be supplied, which may be referred to as automatic mode. Under automatic mode, for example, logos may be selected according to an optically or otherwise scannable indicia, e.g., a bar code or two-dimensional data matrix. The system may then selects a logo from a table of available computer files having graphical information, as discussed above with regard to the manual mode of operation. To farther capitalize on the changeover rapidity between different indicia, custom text fields with unit-specific information, e.g., that will make up perimeter writing, may be combined with various logos in a single graphics file, that can then be sent as a unified image to the laser for etching. These custom fields may include part numbers, certification information, and filtering and insulation performance information.

In one embodiment of the present invention, a laser etching apparatus may be provided in an integrated fashion in an insulating glass production line. For example, after two panes or sheets of glass are applied to a frame by means of adhesive, the glass may then be sealed around the periphery of the frame edge. It may prove preferable in implementing a line for the production of integrated glass units to implement a laser etching apparatus according to the present invention soon before the edge sealing of the insulating glass unit. Accordingly, a laser etching apparatus may be implemented as a production line station which contains a thickness gauge apparatus in order to monitor whether a given IG unit contains a proper gas pressure in the space created by the two opposing panes and the frame. In the event that the gas pressure is found to be incorrect, the gas pressure may be changed to a preferred level, either by the addition of gas into the unit, e.g., via a needle, or gas may be released in a similar fashion. Such gas monitoring is well suited to combination with a laser etching system according to the present invention, because, according to a preferred embodiment, the laser etching station employs an optical sensor to detect the start of the glass as it moves across the station while being moved into position for the etcher, and the tail end of the glass moving across the sensor. The glass thickness can be optically gauged as a function of the length of glass that has moved past the thickness sensor. In other words, a cross section of an insulating glass unit may be derived from the thickness data, showing the thickness at the height of the sensor. This allows windows to be measured and rejected, or adjusted, if their thickness is out of specification, i.e., if the unit is convex or concave.

A control system capable of operating an apparatus according to the present invention may be implemented on a typical personal computer, e.g., a desktop or laptop personal computer which includes a fiber optic control card or other I/O device capable of data communication with the laser device being used.

The present invention may also, naturally, be implemented on workstation, such as those produced by SGI of Mountain View, Calif., USA, or multi-processor machine.

In one embodiment of the present invention, the complete indicia to be etched on the glass is sent to the laser etcher in a single graphics file. However, within this embodiment, several elements may be combined into a single indicia file that may be sent to the laser for etching. For example, a logo may be provided and combined with textual information that is to be indelibly imparted onto the workpiece. This textual information may vary between production runs, or even between workpieces, as the appropriate textual information, retrieved from the workpiece database, is fed to the program for unification with the appropriate logo prior to transmission to the laser as a unified file.

In a preferred embodiment, the internal operation of the etching laser and the operation of the indicia placement system are controlled via one or more computer processors. For example, the laser and indicia placement system may be controlled via a desktop PC. Preferably, a multiprocessor computer, or two or more single processor “standard” PCs may be used to implement the present invention.

In a dual-PC system, for example, one PC may control the function of a laser etcher and a second, PC may run a custom program that may derive and transmit control parameters, e.g., via RS-232 data transmission lines, to the PC or processor controlling the etching laser PC. This second PC, for example, may also be used to control the vertical positioning of the laser, PLC conveyor interface controlling the motion of a line that the etcher of the present invention is integrated with.

The PC executing the indicia formation and orientation software may control the operation of the invention, preferably via data transmission means, from a hardware perspective such as RS-232 Ports, and control cards, such as DIO-24 control cards.

The operator can run the system in either bar coded automatic mode or manual mode. In automatic mode the system will automatically select the logo properties and position the glass by reading the parameters from a file which resides on the computer. The operator can also select to run the system in manual mode, which requires the operator to manually select the logo properties. For example, this mode of operation may be provided in scenarios under which the same indicia and orientation is applied to a similar or identical glass configuration that is being applied on a volume or repeating basis. However, the specific logo artwork is preferably stored in one or more database files, that may be resident on a remote server, for example, or local files, allowing the operator to input many parameters by the selection of a single indiciator.

In a preferred embodiment of the present invention, an apparatus according to the present invention may be implemented as a system containing the following hardware components: One or two PC cabinets, preferably mounted together, with 2 conveyors and a mounted indicia C0₂ laser.

The computers implementing the control of the indicia orientation may also, preferably, control 2 conveyor arms or beams, one pair of conveyor arms in parallel being controlled by a servo motor. A second conveyor arm placed perpendicularly to the first pair of arms, and being slidable along the first pair, may be moved so that the laser device on the proper location on the planar workpiece according to one of two coordinate values, relative to a first edge of the workpiece. The laser device may then be moved into position according to the second of the pair of coordinate values relative to the second edge of the planar workpiece, the second edge being perpendicular to the first edge. This set of perpendicular arms may be referred to generally herein as the gantry, and is discussed in greater detail below.

The processor may be of any type, and may use any number of operating systems, but in a representative embodiment, may be implemented on a “Wintel” platform (i.e., an Intel CPU running a Microsoft Windows operating system.) The preferred embodiment of the present invention may be implemented using two CPUs. These CPUs may be part of a multiprocessor computer, or they may be in separate computer devices, such as personal computers. Generally, herein, the processors will be described running in two personal computers, and thus the term PC may be used, instead of or in addition to “processor” to describe the operation of one of the processors in the preferred embodiment. The various functions of the apparatus may be divided between the processors. For example, one processor may be used the laser, specifically, by feeding a properly configured and oriented image to the laser, and instructing the laser to fire. The other may be used to control the x/y servo/gantry system, as discussed herein.

Returning now, to an embodiment in which one processor, or computer, that is dedicated to the control of the laser marking system, this processor may be linked to a control card which translates instructions from the processor to a transmittable medium, e.g, a fiber-optic link, RS-232 connections, a USB connection, or a network connection such as an Ethernet connection. The software that runs on this computer to control the laser may be termed generally “laser control software.” For example, the year and the quarter may be automatically updated in the indicia transmitted to the laser control module. This information may be updated from information obtained from the operating system, for example. Alternatively, or in addition, the indicia may include the exact date and/or time of manufacture, the location, or the qualities of the glass, as discussed above. This information regarding the qualities of the glass may be included in the indicia automatically, by the inclusion of the relevant text information within the indicia sent to the laser. The information may be automatically supplied based on an identification number of a particular workpiece or group of workpieces having identical indicia information. The qualities or specifications of the workpiece or workpieces may be presented to the indicia-generating software module for incorporation in the complete indicia, including the custom text information, sent to the laser.

In an embodiment using two PCs, the PCs may be configured to exchange information using RS-232 connections via the COM1 ports on the PC, for example. In an embodiment using two PCs, for example, the transmission parameters, for example using an RS-232 COM1 port on a PC must be configured to match the PC running next to it. In a Microsoft Windows environment, for example, this may be accomplished using the “Control Panel” utility.

Indicia elements that are variable, but automatically updated for inclusion in the final indicia sent to the laser control module, may be defined using custom format fields in the software. In this way, the user or installer of an apparatus using the software may define variable values that they wish to have included automatically in indicia, for example, in addition to a logo graphic.

In a preferred embodiment of the present invention system, software according to the present invention may interact with data acquisition cards installed in a PC slot. Preferably, software or an apparatus according to the present invention may be run in one or more of several modes. For example, an Automatic Mode may be provided for operating the indicia build module, for example with automatic input of workpiece characteristics based on bar code identification and database lookup. In this mode, preferably the indicia may adjust automatically based on the type of window, and adjust its size and location automatically. Preferably, a manual mode may also be provided, which may be used to manually set logo type, other indicia components, and orientation. This mode may prove useful when a large volume of identical workpieces are being processed, i.e, the indicia makeup and placement will be identical across all workpieces of the run. A setup or diagnostic mode may also be provided is to allow for the check of AC inputs, communications, and for diagnosing problems.

In a preferred embodiment of the present invention, a data file or database may be provided with defined logo numbers, customer numbers, custom data, and logo “offset from corner” data, preferably according to glass shape. If provided in a data file, for example, a table row could contain the logo number at the first field position, a logo edge offset measurement (each logo type or number may for example may have a unique logo offset); a customer account code, which may also the logos. The filename corresponding to the appropriate logo may be transmitted between modules.

If the present invention is to be operated in manual mode, for example, with volume runs of the same type of insulating glass unit, the operator may be prompted to enter various information for different unit constructions. It will be appreciated that a manual mode, according to the interface provided, allows a user to define or specify the several parameters. For example, the user may scroll through the different logos available, and once the desired logo is selected, press enter. This tells the indicia build module which logo the user wishes to stamp the glass with. While scrolling, specific logo information corresponding to the currently selected logo may be displayed on the screen.

The user may also use input means, such as the +/− keys for example, to select the corner in which the indicia is to be placed (1-4, in an arbitrary sequence, e.g., clockwise starting from upper left. Other shapes may have fewer corners, e.g., 3 for a triangular workpiece, or 2 for an arch).

Preferably, the logo information section of the screen will display a circle or other graphic depicting the logo orientation and corner of the window. The user may also use input means, such as the +/− keys, to scroll through the different logo orientations available. Preferably, a picture in the upper right corner of the screen will show how the logo will appear on the unit, e.g., with a generic “LOGO” graphic display. Any number of orientation graduations may be provided. In one embodiment, twelve options for logo reading are provided as follows: Corner/right, Corner/wrong (i.e., backwards or mirrored, so that the indicia is readable through the opposite side of the glass than the etched side), Center/right, Center/wrong. Left/Right/Right, Left/Right/Wrong, Right/Left/right, Right/Left/Wrong, TopBottom/Right, TopBottom/Wrong, BottomTop/Right, BottomTop/Wrong.

Once the logo orientation is selected the user may press enter and execute the cycle start switch. Preferably, the apparatus will automatically position the glass on the conveyor and begin to place the logo in the proper location after locating the appropriate corner via optical sensors. Alternatively, a ready indiciation that the laser is in proper position may be presented to the user, and the user may start the laser via, for example, a foot pedal control.

The Automatic operation of the present invention proceeds in a similar fashion to the manual operation above, however, all parameters are adjusted according to the parameters of the workpiece, corresponding to the bar code on that workpiece.

In an embodiment of the present invention using dual PCs, the PC that controls the laser etcher may contain a control card. This PC may be implemented using, for example, a Wintel platform, i.e., an Intel processor running a Microsoft Windows operating system. The control information may be sent to the laser device using one of the COM ports of the PC that controls the laser device. The laser is controlled by means of interface commands to the laser to start the etching of the graphical file presented to the laser. The laser may also indiciate to the PC when the etching of the graphical file, or indicia, has been started, when it is complete, and when the optical sensor for the laser housing is retracted. In addition, the bank of PCs will preferably handshake with a PLC that indiciates when the workpiece is in the proper position on the conveyor. Preferably, an automated method of loading workpiece information into the computer is utilized. For example, a bar code for a particular workpiece or a bar code common to a series of workpieces may be read. From a unique identification number, the characteristics of the workpiece may be accessed either from a local database stored on one of the local computers used with the device, or through a database server accessible over a network. These parameters of a workpiece or workpiece series may include, for example, the workpiece type, dimensions, an appropriate base indicia graphics file (i.e., the file prior to addition of variable information, such as a manufacturer logo), variable information such as certification and characteristics for addition to the indicia, and the like. The information may also include shape information, such as a value from a standardized list or library of commonly used shapes, for example, as used with different types of cutting table software. For example, an integer value may be assigned to a rectangle having a certain ratio of length to height, or a triangle having certain side length ratios and interior angles. This data pertaining to a workpiece or workpiece series also preferably contains an integer, set of integers, or other representation of the desired location and orientation of the indicia, for example, based on corner of the workpiece for the indicia, and whether the indicia should face the operator or away from the operator, i.e., as a reverse image that will appear properly from the other side of the workpiece. The orientation information for the indicia may be included in the data for the workpiece, or certain types of orientation information may be derived from the data, depending on the number of fields and range of possible values for each field. An additional variable that may be varied is the polarity of the indicia, in other works, which directly the top of the indicia is pointing, so that the indicia will be installed “right side up,” even if the workpiece on the line is oriented in a different way, e.g., that might be more stable or aid in handling during production. If more fields are used to indiciate the indicia appearance, naturally a smaller range of possible values is necessary for each field. In addition to the information above, the information that has been taken from the workpiece database will preferably include the desired distances between the edge of the workpiece and the perimeter writing for the indicia; and the distance between the logo and the perimeter writing.

The base indicia graphics file may be obtained over a network, or may be stored locally, e.g., loaded from a disk from a third party having a graphical logo file. The central graphics element of the indicia may be referred to generally herein as the logo of the indicia.

In an embodiment of the present invention, a data file may be provided that contains defined logo numbers, customer numbers, custom data, and the required offset from a corner for that logo. The file may start with the logo number at the left most position, for example, with fields containing the logo edge offset distance, thus allows each logo type or number to have a unique logo offset. A field may also be provided for a customer's account code. The logo file sent from the data assembly module to the laser control module may correspond to the customer account number and the logo number. These files, requested by the data assembly module, should exist on the laser control module, e.g., in the PC on which the laser control module is resident. An example of the structure of a data file suitable for implementation of the present invention is as follows:

| logo_number | logo_center | logos_id | logo_name | logo_data1 | logo_data2 | logo_type |
|---|---|---|---|---|---|---|
| 1 | 1.500 | 02345 | CUSTOMER1 | NFRC | PATIO | CLEAR |
| 2 | 1.25 | 05555 | CUSTOMER2 | NFRC | CASEMENT | LOE |

As explained herein, the appropriate logos and text elements may be selected by means of a bar-code or two-dimensional data matrix reader placed conveniently near or on the line on which the workpieces travel. Preferably, the relevant optically-readable data pattern may be read by an automatic reader, which may be placed in such a manner so as to automatically sense such patterns and read the patterns, at which time the workpieces specifications may be read from a local or remote database, in order to set the appropriate parameters for the workpiece and placement and orientation of the indicia. It may be preferable in such an embodiment that the optically-readable data elements are all located at a fixed location relative to one edge of the workpiece, such as a certain distance from the bottom of each workpiece as it is placed on an assembly line.

### BRIEF DESCRIPTION OF THE DRAWINGS

FIG. 1 depicts a plan view of an apparatus according to a representative embodiment of the present invention.

FIG. 2 depicts an system architecture diagram of a control system according to a representative embodiment of the present invention.

FIG. 3 depicts a process state diagram according to a representative embodiment of the present invention.

FIG. 4 depicts a representative application of a method according to an embodiment of the present invention.

FIG. 5 depicts a further representative application of a method according to an embodiment of the present invention.

FIG. 6 depicts a further representative application of a method according to an embodiment of the present invention.

FIG. 7 depicts a plan view of a representative embodiment of the present invention implementing a method according to an embodiment of the invention.

FIG. 8 depicts an alternate plan view of a representative embodiment of the present invention implementing a method according to an embodiment of the invention.

FIG. 9 depicts an alternate plan view of a representative embodiment of the present invention implementing a method according to an embodiment of the invention.

FIG. 10 depicts a plan view of an apparatus according to a representative embodiment of the present invention.

FIG. 11 depicts a plan view of a representative embodiment of the present invention implementing a method according to an embodiment of the invention.

### DETAILED DESCRIPTION OF THE PREFERRED EMBODIMENT

The following detailed description should be read with reference to the drawings, in which like elements in different drawings are numbered identically. The drawings, which are not necessarily to scale, depict selected embodiments and are not intended to limit the scope of the invention. Examples of constructions, materials, dimensions, and manufacturing processes are provided for selected elements. All other elements employ that which is known to those of skill in the field of the invention. Those skilled in the art will recognize that many of the examples provided have suitable alternatives that can be utilized.

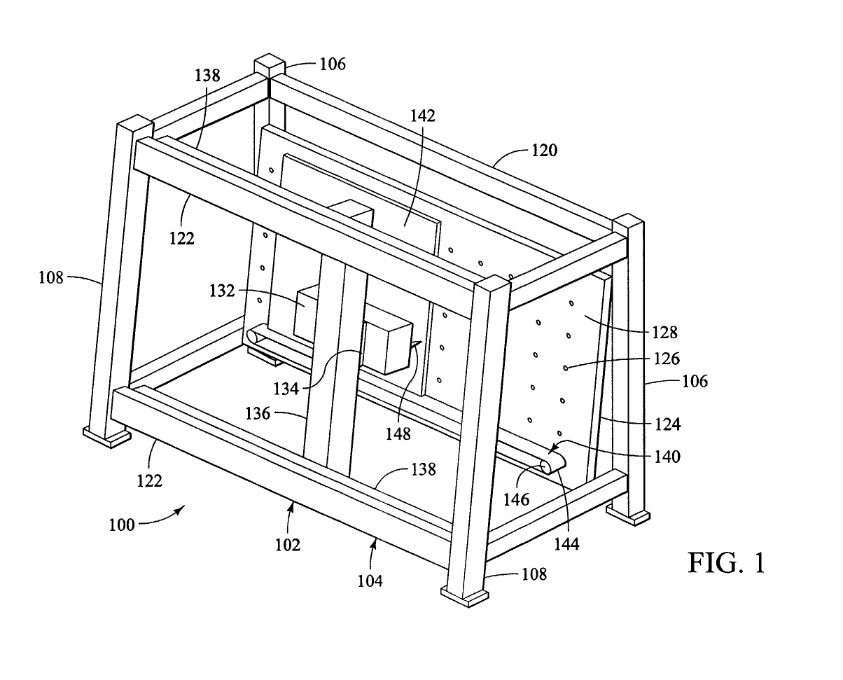

FIG. 1 depicts a plan view of an apparatus according to a representative embodiment of the present invention. FIG. 1 is a perspective view of a work station 100 in accordance with an exemplary embodiment of the present invention. Work station 100 includes a gantry assembly 102. Gantry assembly 102 includes a gantry frame 104 having two rear uprights 106 and two front uprights 108. Gantry frame 104 also includes two rear cross members 120 and two front cross members 122. Gantry frame 104 supports a work platen 124.

In the embodiment of FIG. 1, rear uprights 106 have a generally vertical orientation. In FIG. 1, it may be appreciated that work platen 124 is slightly skewed relative to vertical. In some embodiments, the slight tilt of work platen 124 is desirable. For example, gravity, working in conjunction with the slight tilt of work platen 124 may allow a pane of glass to lean against a front surface 128 of work platen 124. In some embodiments, work platen 124 may be covered with a material having a relatively low coefficient of friction.

In the embodiment of FIG. 1, work platen 124 defines a plurality of holes 126. In one method in accordance with the present invention, a source of pressurized air may be placed in fluid communication with holes 126. Pressurized air exiting holes 126 may allow a pane of glass to pass over work platen 124 with very little friction, in a manner comparable to a puck in an air hockey table arcade game. In another method in accordance with the present invention, a source of low pressure (e.g., a vacuum) may be placed in fluid communication with holes 126. In this exemplary method, low pressure may be coupled to holes 126 in order to selectively fix a pane of glass to front surface 128 of platen 130.

Work station 100 also includes a laser etcher 132, or, as appropriate a laser etching device (not depicted) within a laser housing 132. For purposes of the present invention, laser etcher 132 may be referred to as laser etcher or housing, where either embodiment may be used. In FIG. 1 it may be appreciated that laser etcher 132 is fixed to a movable shuttle 134 of gantry assembly 102. Movable shuttle 134 is coupled to a Y-axis linear actuator 136. One end of Y-axis linear actuator 136 is coupled to a first X-axis linear actuator 138 and a second end of Y-axis linear actuator 136 is coupled to a second X-axis linear actuator 138. In a preferred method in accordance with the present invention, first X-axis linear actuator 138, second X-axis linear actuator 138 and Y-axis linear actuator 136 may be used to selectively position laser etcher 132 within a work plane. In a preferred embodiment, this work plane is generally parallel to work platen 124.

It is to be appreciated that many embodiments of a linear actuator are possible without deviating from the spirit and scope of the present invention. Linear actuators which may be suitable in some applications are commercially available from Lintech Corporation of Monrovia, Calif. and Tol-o-matic Corporation of Hamel, Minn. It is also to be appreciated that laser etcher 132 may comprise various elements without deviating from the spirit and scope of the present invention. For example, laser etcher 132 may comprise a FENIX laser marker, that is commercially available from SYRAD, Inc., of Mukilteo, Wash., USA.

Work station 100 also includes a conveyor 140 extending across front surface 128 of platen 130. In some methods in accordance with the present invention, conveyor 140 may be utilized to transport a pane 142 through work station 100. Conveyor 140 includes a belt 144 and a plurality of rollers 146. In the embodiment of FIG. 1, pane 142 is shown resting on belt 144 of conveyor 140. Work station 100 may be incorporated into a longer processing line having multiple work stations, each having a different function or effecting a step in processing a workpiece 142. Preferably, a similar transport apparatus 140 will be used at each work station to provide for convenient movement of the workpiece 142 between various work stations. A laser beam 148 produced by laser etcher 132 is shown etching indicia onto workpiece 142 in accordance with an exemplary method of the present invention.

In FIG. 1, it may be appreciated that movable shuttle 134 is coupled to gantry assembly 102. In a preferred embodiment, gantry assembly 102 is capable of moving movable shuttle 134 along two dimensions in a plane adjacent a sheet of planar material 142 being processed in a processing line, e.g., an IG glass unit manufacturing line. Various embodiments of gantry assembly 102 are possible without deviating from the spirit and scope of the present invention. For example, gantry assembly 102 may include one or more linear actuators and one or more rotary actuators.

When workpiece 142 is in a certain position, for example when it has reached a stop bar (not depicted in FIG. 1, or its presence at a certain point along belt 140 is sensed by an optical sensor placed on or in work platen 124, this leading edge against a stop bar (not depicted) or at the point of optical sensor may be taken as a leading or reference edge, from which an offset along the two dimensions of the planar workpiece 142, the x and y axes. This offset may be calculated based on the desired corner location for the indicia, and the placement relative to that corner, for example, as will be discussed herein.

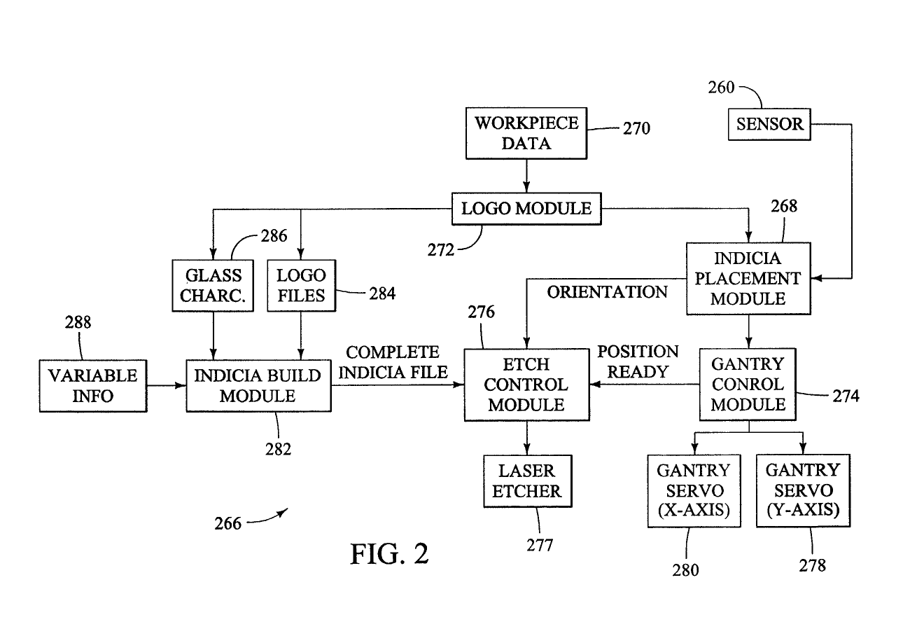

FIG. 2 depicts an system architecture diagram of a control system according to a representative embodiment of the present invention. FIG. 2 is a block diagram of a system 266 in accordance with an exemplary embodiment of the present invention. In FIG. 2 it may be appreciated that system 266 includes a sensor 260. In some embodiments of the present invention, sensor 260 may be used to locate an appropriate corner of a pane or a leading edge, as previously discussed. Having located the desired corner, an indicia placement module 268 of system 266 may be used to determine the position of a desired logo center relative to the identified corner.

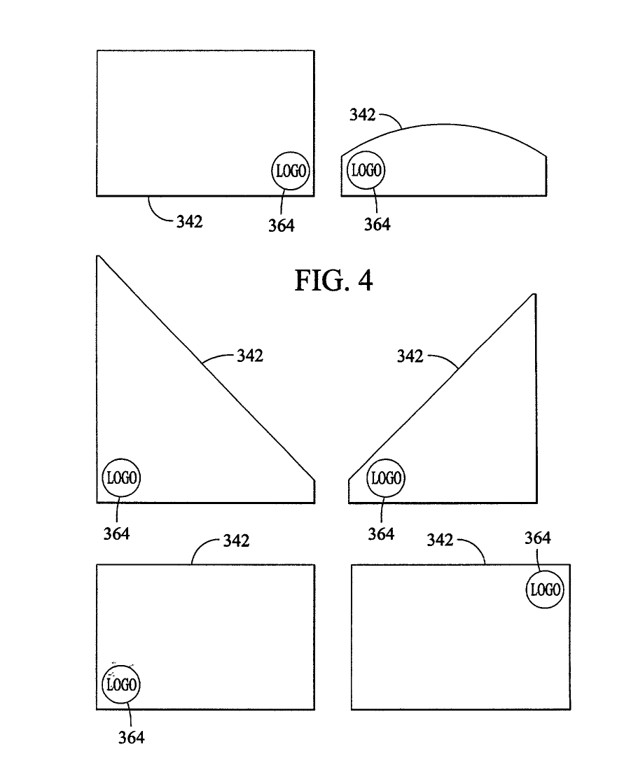

After workpiece data 270 is received from a database, for example, locally or from a remote computer over a network (not depicted), these specifications, including the glass dimensions and shape, customer, NFRC and other text information, logo graphics file, and other indicia specifications, are combined by Logo Module 272. Logo Module 272, and the various modules of the present invention, may be a software module, routine, executable file, function call, or hard-wired computer module, as may be best expected to balance between ease of maintenance and upgrades, durability, adaptability, repeatability, number of units to be produced, and like considerations. Logo Module 272 combines the various components of the indicia, e.g. logo and text, into a single graphics file that can be transmitted to Indicia Placement Module 268. Indicia placement module, using workpiece specifications including dimensions and shape, calculates an offset from an edge using predetermined offset calculations which may be expected to result in placement in what will be perceived by human users of the workpiece as, for example, as aesthetically proper placement, usually without significantly obtruding into the workpiece as a whole, as depicted in FIGS. 4 through 6 herein. In other words, the indicia placement will appear to be properly “centered” in the corner, but not intrude unduly into the workpiece.

Continuing with FIG. 2, Indicia Placement Module 268 output is preferably transmitted to Gantry Control Module 274 and Etch Control Module 276. Indicia Placement Module 268 may instruct Gantry Control Module to move laser etcher 132 to a particular indicia target area on the basis of offset from a leading reference edge and bottom reference edge along belt 144, for example. Indicia Placement Module may also instruct Gantry Control Module to move laser etcher 132 to an indicia target location based on an offset from a reference corner that laser etcher may itself locate using optical sensors located within laser etcher device 132 or within the same housing as the laser device housed within a housing 132. If the indicia target area is specified as an offset from a reference corner of the workpiece. Gantry control module may then move laser housing 132 towards that reference corner until an optical sensor within laser housing 132 indiciates that one edge of the workpiece has been reached, after which Gantry Control Module 274 may back away from that edge by the offset specified by Indicia Placement Module 268. This may be effected, for example, by instructing Gantry Servo (Y-Axis) 278 to move away from a located horizontal edge of workpiece 142 of FIG. 1. Thereafter, Gantry Control Module may move laser housing 132 towards the other reference edge, for example in this illustrative case by moving Gantry Servo (X-Axis) 280 towards the vertical edge until optical sensor indiciates that the vertical edge of the reference corner has been reached, after which the laser housing 132 may be “backed up,” i.e., moved back towards the interior of the planar area of the workpiece, a distance equal to the x-axis offset specified by Indicia Placement Module 268.

Upon placement of laser device or laser housing 132 over the indicia target area, a “position ready” or similar ready command may be transmitted to Etch Control Module 276, whereupon Etch Control Module 276 may instruct Laser Etcher 277 according to Orientation/Rotation information received from Indicia Placement Module 268. For purposes of FIG. 2, Laser Etcher 277 may include, in addition to physical laser etcher apparatus 132, control software for physical laser etcher 132, referred to collectively as Laser Etcher 277. Orientation/Rotation information may be incorporated into a graphics file sent to the Etch Control Module 276 by Indicia Build Module 282, i.e., a graphics file is sent to the Etch Control Module already rotated, so that the Etch Control Module does not impart rotation or change the orientation of the graphics file received from Indicia Build Module 282. In this implementation of the invention, orientation information sent from Indicia Placement Module 268 would be sent to Indicia Build Module 282 rather than to Etch Control Module 276. Orientation information may include, both the direction that the top of the indicia image is pointing (i.e., its rotation), in addition to the direction it is facing relative to the workpiece plane, i.e., whether the image is readable from the from of the plane, or instead is etched backwards so that it is readable from the other side of the plane, e.g., through a pane a glass. Indicia Build Module 282 may receive subcomponents of the complete indicia, e.g., the logo graphics file 284 or glass characteristics 286, such as NFRC ratings, to be included preferably in an single graphics file sent to Etch Control Module 276 for forwarding to Laser Etcher 277. Additionally, Variable Information 288 may be supplied from a source other than the Workpiece Data 270 pulled from a workpiece database, for example.

Variable Information 288 may preferably include information available at run time, such as that accessible from the operating system or other sources. This Variable Information 288 may include, for example, sequential serial numbers; place, date or time of manufacture or etching, or other information that may not be reasonably supplied in Workpiece Data 270. This Variable Information may be combined by Indicia Build Module 282 for forwarding to Etch Control Module 276. Alternatively, such Variable Information 282 may be transmitted directly to Laser Etcher 277, if desired, although this may be expected to add overhead to Laser Etcher 277 in comparison with Laser Etcher's receipt of a single graphics file from Etch Control Module 276, the single graphics file already incorporating Variable Information 288. In one embodiment of the present invention, the laser housing 132 or laser device may be retracted from the workpiece during travel, in order to avoid accidental contact with the workpiece during housing movement. The laser housing or laser device may then be advanced towards the workpiece to an optimal firing distance when the laser lens is positioned over the indicia target location. This movement may be effected by a servo motor similar to that used with the linear actuators for the X and Y travel.

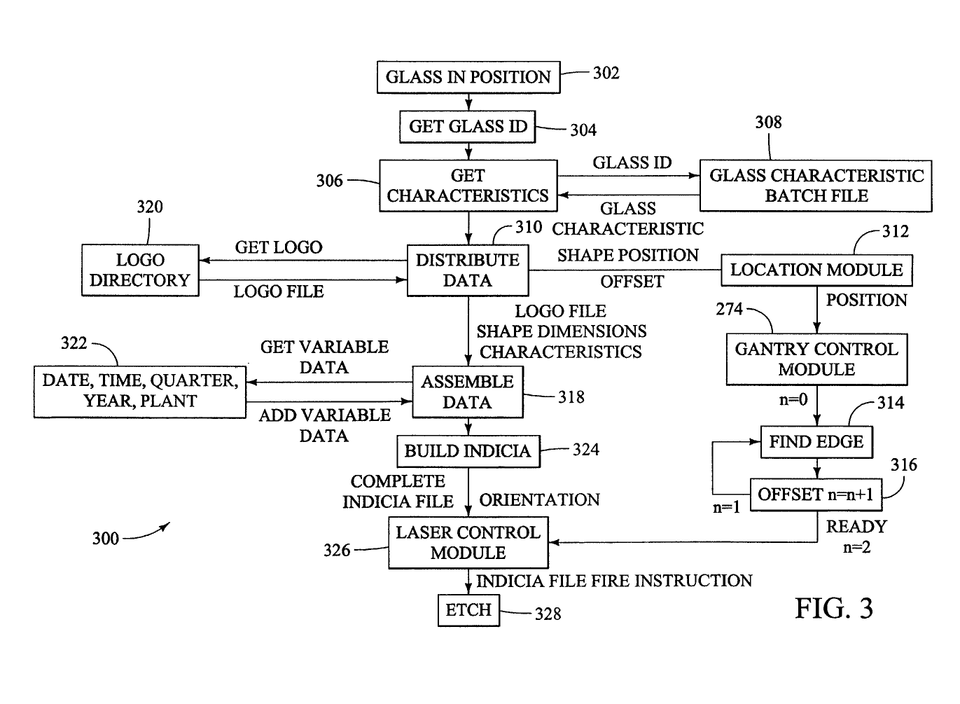

FIG. 3 depicts a process state diagram according to a representative embodiment of the present invention. FIG. 3 is a process or flow chart illustrating an exemplary method in accordance with the present invention. In FIG. 3, it may be appreciated that a method in accordance with the present invention may include the step of finding a corner of a pane. A method in accordance with the present invention may also include the step of calculating a logo center position. In addition to offset formulas for indicia placement based on a specified shape type and a certain x and y distance from a leading reference edge and bottom reference edge resting against belt 144, indicia location may be determined based on an angle that is central between the edges of the workpiece where the indicia is to be placed, together with a distance along this angle from point that is that corner of the workpiece where the edges meet. This approach, which may be based on polar coordinates, may also be converted into an x-y offset along the horizontal and vertical axes, respectively, which are derived from the polar coordinates according to standard geometric principles. Alternatively, or in addition to this system, x-y offsets and attendant instructions for the movement of the x-y gantry system, may be based on positioning of the laser target area on the workpiece according to trigonometric principles.

In FIG. 3, a method of controlling the etching of a workpiece is indiciated generally at 300, although it will be appreciated that the ordering of the process is not crucial in all respects, and the processes may in certain cases be carried out in a different order. FIG. 3 represents generally a suitable process flow, although certain modules are represented where this may increase clarity. Upon the workpiece being in a suitable position at Workstation 100 of FIG. 1, for example at a stop bar or at optical leading edge sensor, a signal may be generated that the workpiece is in position as indiciated at state 302. Upon being in position or while a workpiece is reaching the processing position, the workpiece identification may be entered into the system as indiciated by process 304. This process may involve manual entry of a unique identifier for a workpiece; or of a type, series, or model of workpiece; preferably, however, this information will be gathered or entered in an automated fashion, for example, by the optical recognition and decoding of a bar code, character set, two dimensional data matrix, or the like. Upon obtaining a unique or series identifier, workpiece characteristics may be obtained (process 306 obtaining data from module 308, which may represent a composite or database of Workpiece Data 270 of FIG. 2. This Workpiece Data 270 of FIG. 2 may then be distributed to various modules needing the information, as indiciated by process 310 of FIG. 3. For example, the shape information and desired offset may be transmitted to Location Module 312. This Location Module positioning information may be transmitted to effect the desired indicia target location. For example, Gantry Control Module 274 may convert general positioning information from Location Module 312 into specific control signals to Gantry Servos 278 and 280 of FIG. 2. The Gantry Control Module 274 may be instructed to find the proper corner for placement according to one of several methods, as described previously. The corner may be found based on an offset distance from a reference edge such as a retractable stop bar that stops the glass when it reaches its position at workstation 100, and the reference edge of the bottom resting on conveyor belt 144. Alternatively, the proper corner may be found by moving towards one edge that forms the corner, optically detecting that edge at 314, backing up the distance of the desired offset on that axis at 316, and then repeating the process with the other edge forming that corner, i.e, processes 314 and 316 are each repeated twice, and the position of the laser etcher is ready when n=2.

Simultaneously to laser housing positioning as discussed above or at any time prior to laser firing, an indicia file may be built for transmission to the laser etching device. As indiciated at 318. This may involve the assembling of data from the Data Distribution Process 310. A suitable central logo graphic for the indicia may be obtained, for example, from a local directory, or from a local or remote database, by the Data Distribution Process 310, as depicted at 320. Alternatively, Data Assembly Process 318 may also obtain the suitable logo file. Data Assembly Process 318 may then obtain variable data not subject to prior storage, as indiciated at 322. This may include data obtained from a computer operating system, such as date, fiscal quarter, or year of manufacture, or may include plant location information, sequential serial number information, and the like. When all data is assembled for the indicia, including the logo from 320, variable text information 322, and characteristics 308, the data may be assembled at 324 into one or more graphics files that may be sent to laser etcher as a single or set of graphics files for etching. Orientation (mirror image/backwards-forwards) and rotation information may be incorporated into the graphics file sent to the laser etcher, i.e., the image will already be rotated so that the image imparted will be facing and pointing the correct way, even if this information is not known to the laser etcher—in other words, these changes are already inherent in the indicia file, and all the etcher has to do is etch the already rotated image. Alternatively, the image may be presented in its “forward/right side up” configuration, and the rotation and orientation specifications may be transmitted separately to the Laser Control Module 326 for implementation by the laser etcher. Upon a ready indiciation from the Gantry Control Module process 274, 314, and 316, and upon the receipt of a build indicia file from Build Indicia Process 324, Laser Control Module 326 may instruct laser device 132 to etch the indicia graphic into the workpiece at 328. Alternatively, Laser Control Module may build the indicia from a number of indicia elements obtained from the Build Indicia Process 324, or may supply certain run-time parameters such as those received from 322, and implement rotation and orientation instructions directly to laser device 132.

FIG. 4 depicts a representative application of a method according to an embodiment of the present invention. FIG. 4 is a plan view illustrating a plurality of panes 342. Each pane 342 includes a logo 364. FIG. 4 illustrates a sample set of shapes and indicia locations that may be utilized in conjunction with systems and methods in accordance with the present invention. FIG. 4 also illustrates how a gantry in accordance with the present invention has the ability to place an indicia at any location on a pane. FIG. 4 further illustrates how a gantry in accordance with the present invention has the ability to automatically place an indicia on panes having various shapes in a location that is perceived to be properly spaced from a workpiece corner.

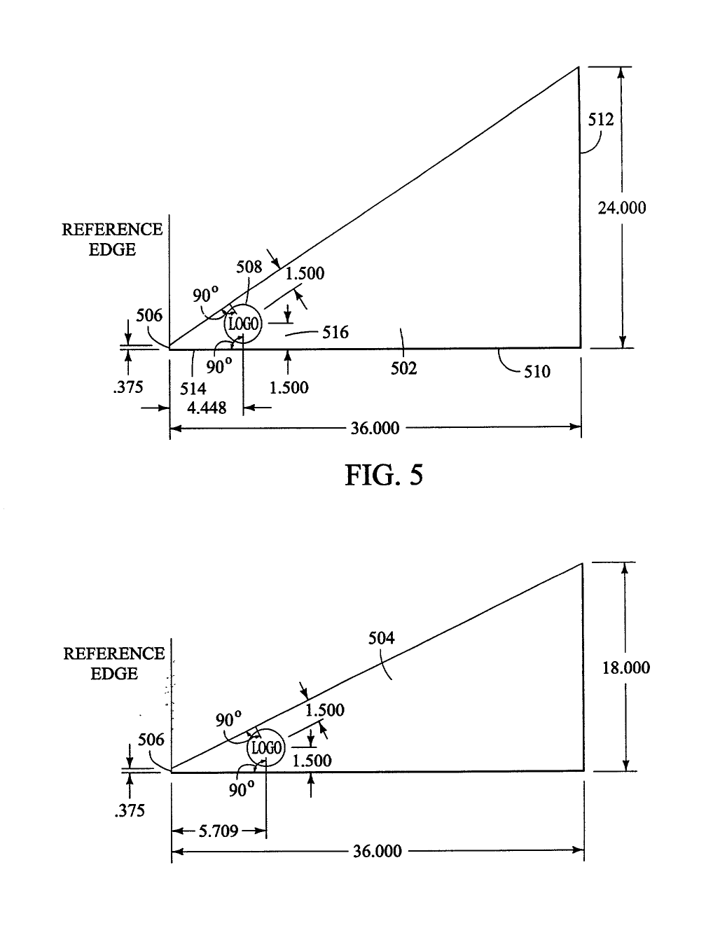

FIG. 5 depicts a further representative application of a method according to an embodiment of the present invention. FIG. 5 demonstrates how an indicia position calculator in accordance with the present invention keeps the indicia center within quality control specifications regardless of the angle of a triangular shaped sheet of glass. An indicia center of 1.5 inches is illustrated in FIG. 5 for example purposes only; the data file used will dictate the indicia center for a particular application. FIG. 5 depicts two triangular workpieces 502 and 504. Based on distance from a reference edge 506, and by the application of trigonometric principles or principles of polar geometry, an aesthetically pleasing, repeatable, standardized indicia location 508 is arrived at. The position of reference edge 506 relative to workstation 100 of FIG. 1, and relative to laser etcher/housing 132 may be determined, for example, by the placement of workpiece 502, 504 against a stop bar upon arrival in workstation 100 of FIG. 1. Alterative, reference edge 506 may be determined by the optical sensing of the arrival of the reference edge 506 at a certain point along work platen 128 of FIG. 1. By the application of trigonometric principles, an x and y-axis offset from the reference edge, and from the bottom of the workpiece, can be determined that will result in indicia placement, for example, 1.5″ at a right angle from the workpiece edge at the specified indicia corner. For workpiece 502, a right triangle having a base 510 of 36″ and a height 512 of 24″, an x-axis offset 514 of 4.448″ from reference edge 506, and a y-axis offset 516 of 1.5″ will provide the desired orthogonal offset of 1.5″. Naturally, the desired offset may be calculated according to a desired right angle offset other than 1.5″, based on the preference of the manufacturer, customer, or the like. It will be appreciated that while the indicia location is represented as a circle, the indicia may be of any shape centered on the offset center of the indicia position.

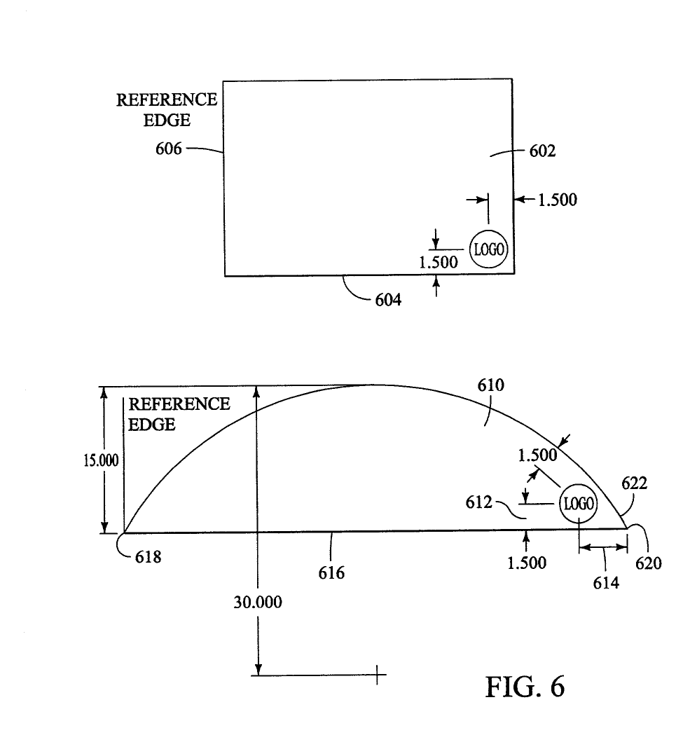

FIG. 6 depicts a further representative application of a method according to an embodiment of the present invention. FIG. 6 demonstrates how a logo position calculator in accordance with the present invention keeps the indicia center within quality control specifications regardless of the size or shape of the window. This accuracy and repeatability would be nearly impossible by manual methods or require repeated time-consuming and painstaking measurement. An indicia center of 1.5 inches is illustrated in FIG. 6 for example purposes only; the data file used will dictate the logo center for a particular application. The indicia position calculator maintains the same specification on arc shaped sheets of glass as it does on rectangular shaped pieces of glass.

As illustrated in FIG. 6, an orthogonal offset of 1.5″, for example, on rectangular workpiece 602 is derived from an equal x-axis and y-axis offset. of 1.5″ in each case, from the target corner. This may also be derived by subtracting the x-axis offset value, 1.5″ from the width (edge 604) of workpiece 602, and moving the laser etcher this amount from reference edge 606, assuming that the workpiece moves from right to left when entering workstation 100 of FIG. 1. The y-axis offset may be determined with reference to, for example, the bottom edge of the workpiece resting on a conveyor system. Workpiece 610 may have an indicia location determined by trigonometric or polar geometric principles to have an orthogonal 1.5″ offset from the straight bottom and curved top, with a corresponding y-axis offset 612 and x-axis offset of 614. These offsets may be measured by distance from the bottom edge 616 and reference edge 618, or may be measured directly from optically-detected corner 620, as discussed previously. Upon determination of the desired indicia location, laser housing 132 may then be moved towards the interior of the workpiece so that the laser lens of the laser etching device is positioned over that point on the workpiece, i.e., the indicia target location. The x- and y-axis offsets for proper indicia placement for all workpiece types may be calculated and hard-coded into the workpiece characteristics database, or may be calculated on-the-fly at run time, depending on speed, processor power, convenience, variety or workpiece types, and other relevant considerations. Once the indicia target location is reached by the laser housing 132, a command to effect the indicia may be given to the laser device housed within laser housing 132. Upon the completion of the laser, a signal may be received by the laser device that etching is complete. At this time, the workpiece may be evacuated from the workstation, preferably by automation. If any other processes are effected on the workpiece on the same workstation in conjunction with the laser etching, these processes may be completed prior to evacuation if they have not been completed prior to the completion of the etching process.

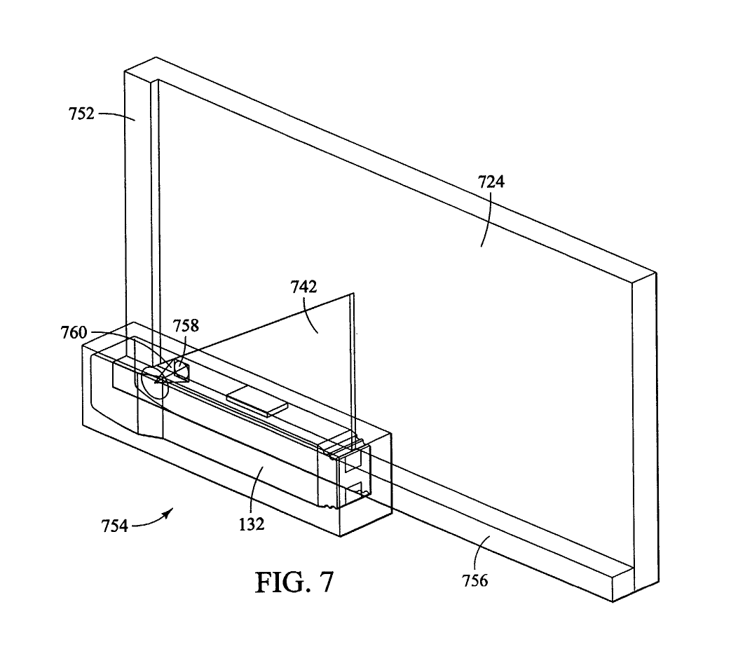

FIG. 7 depicts a plan view of a representative embodiment of the present invention implementing a method according to an embodiment of the invention. FIG. 7 is a perspective view of an assembly 754 in accordance with an exemplary embodiment of the present invention. FIG. 7 illustrates how a system in accordance with the present invention may be used to place a logo at any location on a workpiece 742 which may be, for example, a pane of glass, an insulated glass unit assembly, or piece of sheet metal. FIG. 7 also illustrates how a system in accordance with the present invention may be used with workpieces having any shape. Assembly 754 of FIG. 7 includes a work platen 724. A workpiece 742 is disposed upon a front surface of work platen 724. In the embodiment of FIG. 7, workpiece 742 has been positioned against a reference edge 752 or retractable/movable stop bar. This bar may be used to stop a workpiece in a set position entering a work station such as work station 100 of FIG. 1 where the workpiece enters work station 100 from the right. Also in the embodiment of FIG. 7, workpiece 742 is resting on a support surface 756 which may also be a conveyor apparatus as belt 144 of FIG. 1.

In the embodiment of FIG. 7, a laser etcher 132 has been positioned proximate a lower left corner of workpiece 742 so that its lens is directly adjacent to indicia target location 758. Laser etcher 132 may be selectively positioned, for example, by a gantry in accordance with the present invention. In FIG. 7, laser radiation 760 is shown focused on indicia target 758 of workpiece 742. In the embodiment of FIG. 7, pane 742 has a generally triangular shape comparable of workpiece 502 of FIG. 5.

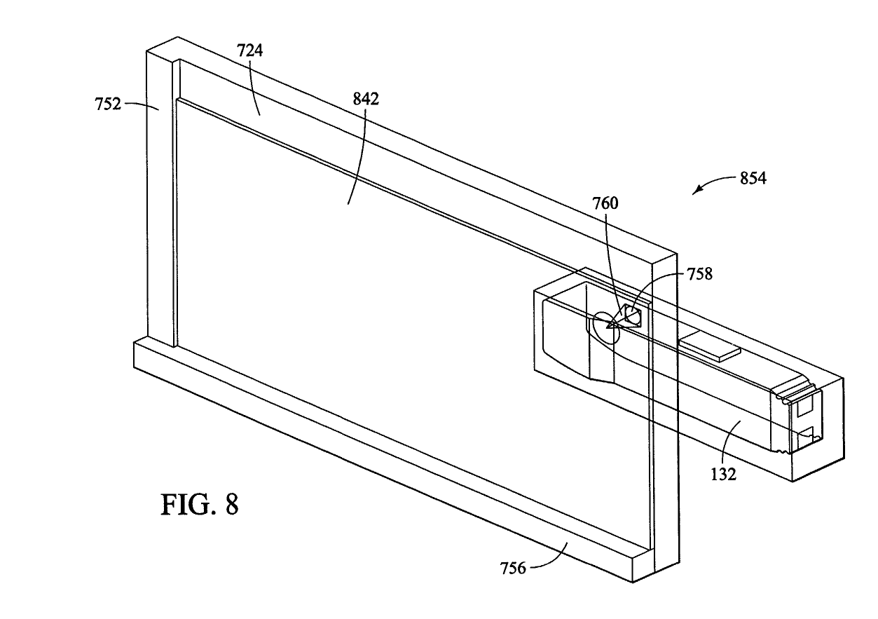

FIG. 8 depicts an alternate plan view of a representative embodiment of the present invention implementing a method according to an embodiment of the invention. FIG. 8 is a perspective view of an additional assembly 854 in accordance with an exemplary embodiment of the present invention. FIG. 8 illustrates how a system in accordance with the present invention may be used to place an indicia on any location on a workpiece 842. FIG. 8 also illustrates how a system in accordance with the present invention may be used with workpieces having any shape. Assembly 754 of FIG. 8 includes a work platen 724. A workpiece 842 is disposed upon a front surface of work platen 724. In the embodiment of FIG. 8, workpiece 842 has been positioned against a reference edge or retractable/removable stop bar 752. Also in the embodiment of FIG. 8, pane 742 is resting on a support surface or conveyor 756.

In the embodiment of FIG. 8, a laser etcher 132 has been positioned proximate an upper right corner of workpiece 842. Laser etcher 132 may be selectively positioned, for example, by a gantry in accordance with the present invention. In FIG. 8, laser radiation 760 is shown focused on an indicia target location 758 of workpiece 842. In the embodiment of FIG. 8, workpiece 842 has a generally rectangular shape, comparable to that of workpiece 602 of FIG. 6.

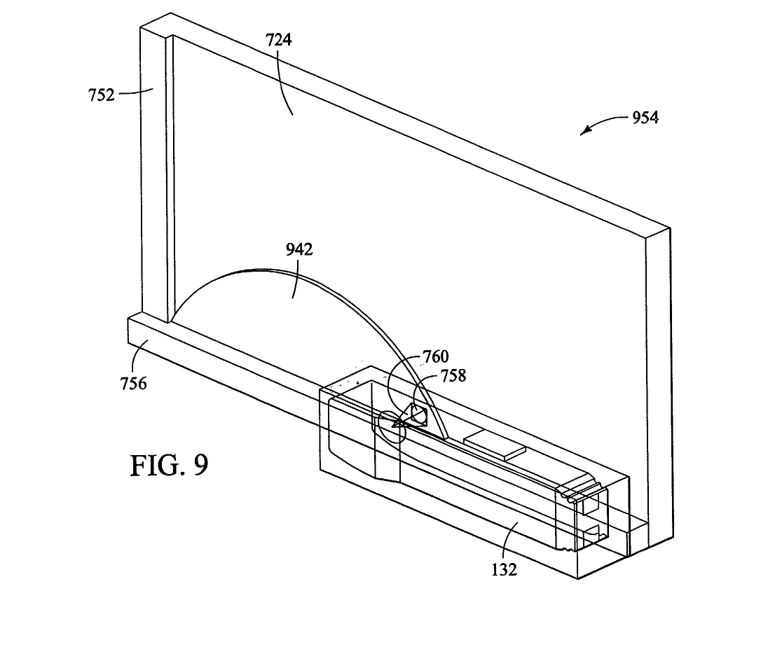

FIG. 9 depicts an alternate plan view of a representative embodiment of the present invention implementing a method according to an embodiment of the invention. FIG. 9 is a perspective view of yet another assembly 954 in accordance with an exemplary embodiment of the present invention. FIG. 9 illustrates how a system in accordance with the present invention may be used to place an indicia at any location on a workpiece 942. FIG. 9 also illustrates how a system in accordance with the present invention may be used with workpieces having any shape. Assembly 954 of FIG. 9 includes a work platen 924. A workpiece 942 is disposed upon a front surface of work platen 724. In the embodiment of FIG. 9, workpiece 942 has been positioned against a reference edge or removable/retractable stop bar 752. Also in the embodiment of FIG. 9, workpiece 942 is resting on a support surface or conveyor 756.

In the embodiment of FIG. 9, a laser etcher 132 has been positioned proximate a lower right corner of workpiece 942. Laser etcher 132 may be selectively positioned, for example, by a gantry in accordance with the present invention. In FIG. 9, laser radiation 760 is shown focused on an indicia target location 758 of workpiece 942. In the embodiment of FIG. 9, workpiece 942 includes a generally arc-shaped upper side, comparable to workpiece 610 of FIG. 6.

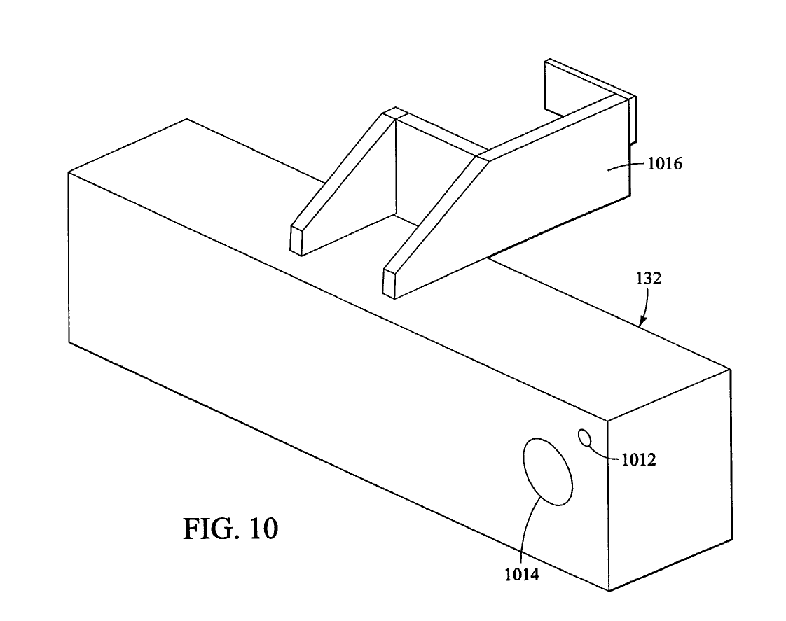

FIG. 10 depicts a plan view of an apparatus according to a representative embodiment of the present invention FIG. 10 is a perspective view of a laser etcher housing 132 in accordance with an exemplary embodiment of the present invention. In FIG. 10 it may be appreciated that laser etcher 132 includes an optical sensor 1012 as described in operation previously. For example, in some embodiments, sensor 1012 may be used to identify a corner of a workpiece. In FIG. 10 it may also be appreciated that laser etcher housing 132 includes an aperture 1014. In some embodiments of the present invention, laser radiation may exit laser etcher housing 132 by passing through aperture 1014, which is positioned in line with a lens of a laser etching device housed within laser etcher housing 132. Embodiments of the present invention are possible in which a distance between optical sensor 1012 and a laser beam focus area passing through aperture 1014 is known and fixed. Embodiments of the present invention are also possible in which this value is stored in a memory of a system in accordance with the present invention in order to admit of accurate placement of indicia as previously discussed.

A laser device capable of etching indicia on glass in a varied orientation about an axis, in accordance with the present invention and as depicted in FIG. 1, may include a pair of opposing x-track members 122 disposed along a first dimension, and a y-track member 136 being movably mounted along a second dimension perpendicular to the x-track members 233; the y-track 136 further being mounted between the x-track members and movable along the x-track members. A laser device optionally being mounted within a housing 132, may be in turn mounted on a shuttle 134, the shuttle 134 being movably mounted on the y-track, whereas the laser housing device 132 is positionable along the y-track 136, and the y-track is positionable along the x-track 122, according to an optimal indicia location, as previously discussed. Laser housing 132 may be filled with a y-track engaging arm 1016, as depicted in FIG. 9. This arm 1016 may be fixed to shuttle 134 as depicted in FIG. 1, or may alternatively engaged or connected within y-track 136 of FIG. 1, permitting vertical movement of laser housing 132, and horizontal movement by means of x-tracks 122.

The device described above may further include an indicia location calculator capable of determining an optimal indicia location given the dimensions of the workpiece to which indicia is to be etched. The device described above may also include a workpiece processing line moving on a plane, the line disposed adjacent the x-track members, the line having a direction along the first dimension, such that the laser device may be placed adjacent and aimed perpendicularly to the plane of the workpiece line, for example, moving right to left through the work station depicted in FIG. 1. The device described above may also include a first motor being in driving communication with the y-track 136 and capable of moving the y-track 136 along the first dimension, and a second motor being in driving communication with the shuttle 134 and being capable of moving the shuttle and/or laser etcher housing 132 along the second dimension.

Upon completion of the etching process as to any one workpiece, a signal may be generated by the laser etcher 132 or laser etcher control module 276 of FIG. 2 that etching is complete. Whereupon, the workpiece may be sent to any further processing by belt 144 of FIG. 1 to a receiving workstation or conveyor, for example, located to the left side of the workstation 100 as it is viewed in FIG. 1. This motion may be effected preferably after the removal or retraction of any reference edge or stop bar such as reference edge 752 of FIGS. 7-9.

The invention is described primarily with respect to operation on individual workpieces, e.g., sheets of glass, that may previously or later be incorporated into insulating glass units having a sealed gas space between the panes of glass, and being surrounded by a frame that makes up the edge of the unit. If insulating glass is incorporated into an insulating glass unit, the present invention may also be used on insulating glass units that are already assembled. Optical sensors which detect the edge of the glass unit may be used, as described above with single panes, to find a suitable location generally located in the corner of an insulating glass unit. In insulating glass units where a frame extends partially over the surface of one or both of the glass surfaces, the invention may be used to impart indicia in a suitable, aesthetically pleasing location in the viewable corner of an insulating glass unit, although if desired, this may be further from the actual corner of the glass panes themselves, which may be obscured behind a frame. The present invention, when used with assembled insulating glass units, may be used insures that the indicia information will be visible in spite of the frame overlapping the surface of the window, and will also be in the apparent corner of the window as seen by later users of the unit.

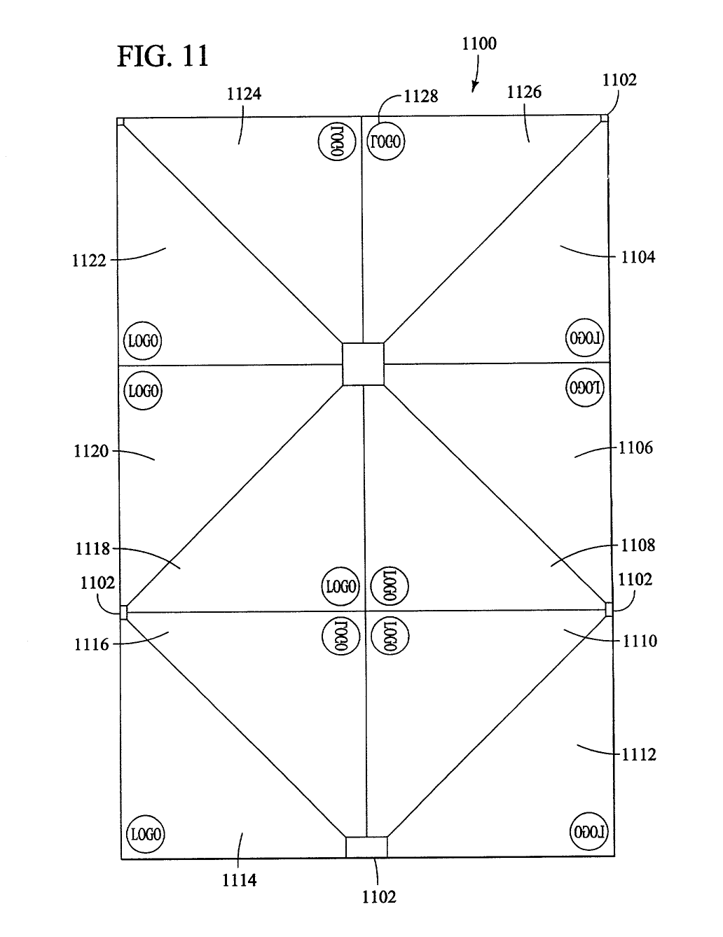

The present invention, in an alternate embodiment, may be implemented in conjunction with a glass cutting table, or integrated with such table. For example, FIG. 11 depicts a plan view of a representative embodiment of the present invention implementing a method according to an embodiment of the invention. FIG. 11 depicts a layout of pane shapes 1100 on single sheet of glass 1102, configured to be split up into various sub-panes, or “lites” of glass. This process of configuring glass shapes to be cut from single sheet 1102, naturally, is generally carried out so as to minimize the amount of wasted glass that cannot be used, according to various optimizing methods. FIG. 11 depicts a multiplicity of lites 1104 through 1126, similar to that of shape 342 of FIG. 4, optimized, i.e., efficiently set out on single sheet of glass 1102. In this embodiment of the present invention, the gantry system depicted in FIG. 1 in a generally vertical arrangement, i.e., the plane along which the laser etcher or housing 132 travels is generally vertical, thus the y dimension is orthogonal to the floor. The system 100 of FIG. 1 could also be implemented horizontally, such that the x and y dimensions are both parallel to the floor. Suitable support structures for X-axis linear actuators 138 and Y-axis linear actuator 136, extending from front uprights 108 to the floor, could support workstation 100 of FIG. 1 so that the formerly upright members 108 are parallel to the floor. In this way, with laser beam 148 pointing generally down at the floor, the device 100 of FIG. 1 could be combined with a cutting table to provide for single station etching and cutting. According to this embodiment of the invention, indicia placement may be integrated with the definition of a group of lites such as 1104-1126 on glass sheet 1100 of FIG. 11. For example, these lites may be defined with the use of a cutting table optimizing computer program. Before, after, or simultaneously with the execution of the cuts defining the lites, the present invention may be utilized to impart indicia on each or several of the various lites, as shown by indicia 1128 in FIG. 11. For example, each lite may have a unique logo, pictorial or text information, or other indicia components, or indicia size, each desired indicia being sent to or effected by the laser etcher 132 of FIG. 1 according to the lite that the laser etcher 132 was positioned over. The position of each indicia 1128 to be imparted by the laser etcher may be determined by offset from optical cues correspond to individual lites, such as lite cut lines, but preferably will be calculated by an x and y offset from optically-detected edge(s), or as an x and y offset from a reference edge or reference corner at a fixed position relative to workstation 100 disposed above the cutting table, as previously discussed with reference to alternate embodiments. Following the placement of a first indicia 1128 on glass sheet 1102 according to an offset from an optically-detected edge or corner, or offset from a reference edge or corner, each subsequent indicia may be placed according to its offset from the center of a nearby indicia, according to a total x and y offset from the reference edge(s) or optically-detected edge(s). In a preferred embodiment, this total x and y offset, and the resultant required x and y movement from a prior-placed indicia will be calculated statically or dynamically with reference to the immediately prior indicia. Alternatively, each indicia placement may be independently positioned by moving laser etcher 132 of FIG. 1 an appropriate distance from the reference edge(s) or optically-detected edge(s), with the etcher 132 returning to a home location or reference edge or corner between indicia etch events. In addition to variation among the indicia elements, and as shown in FIG. 11, the indicia for each lite may be varied by orientation and direction (i.e., whether the text is properly read through the glass from the opposite side of the etching as opposed to from the etched side). Preferably, in an embodiment of the present invention in which the etching workstation 100 of FIG. 1 is adapted for use with a cutting table, the X and Y travel range of the etcher or etcher housing 132 will extend to the edges of the cutting table so that indicia may be placed anywhere on any sheet of glass that may be processed on the corresponding cutting table.

In addition to an embodiment of the present invention in which work station 100 is incorporated with or positioned over a cutting table, prior to cutting of individual lites 1104-1126, the multiple indicia shown on single piece of glass 1102 of FIG. 11 may be imparted to single glass sheet 1102 prior to the placement of glass sheet 1102 on a cutting table. In this embodiment of the present invention, the placement of the various indicia 1128 will preferably be according to x and y offset from an optically-detected edge(s) of glass sheet 1102, or will be determined by x and y offset from a reference edge or edges. In this embodiment of the present invention, where various indicia 1128 are imparted to glass sheet 1102 prior to placement at a glass table, the indicia may be imparted at a workstation 100 as depicted in FIG. 1, i.e., where the y axis of the gantry system is orthogonal to the floor; alternatively, the gantry system may be implemented parallel to the floor, as discussed with reference to the integration with the cutting table discussed above; naturally, the integration of gantry system 100 with or the incorporation of the gantry system 100 into a cutting table apparatus is not required in order to implement the gantry system 100 as parallel to the floor if space or other production considerations dictate.

While a representative embodiment of the present invention has been described, it will be appreciated by those skilled in the art that a variety of embodiments are possible, including variations in the computing environment and platform, software architecture, and the like, without departing from the present invention. While the invention as described herein refers primarily to laser etching on a workpiece such as glass, it will be appreciated by those skilled in the art that any type of workpiece or material susceptible to laser radiation may be etched with the present invention. Furthermore, while the present invention is discussed primarily for use in order to impart marks or other visual effects on a workpiece, it will be appreciated by those skilled in the art that the present invention may be used, and “etching” may be interpreted to include the use of the apparatus to effect various other tasks by the imparting of increased power or duration of laser energy. For example, the present invention may be used for drilling, carving, cutting, scoring, perforating, or other material tasks in which the laser is used to make a hole or cut pattern to some degree through a workpiece, including all the way through the workpiece.

What is claimed is:

1. For a laser device capable of etching indicia on a workpiece, an improved indicia positioning apparatus, the improvement comprising:
a pair of opposing x-track members disposed along a first dimension:
a y-track member being movably mounted along a second dimension perpendicular to said x-track members, said y-track further being mounted between said x-track members and movable along said x-track members;
a shuttle capable of having the laser device being mounted thereon, said shuttle being movably mounted on the y-track member, wherein the laser device is positionable along the y-track member, and the y-track member is positionable along the x-track member, according to a desired indicia location.

2. The indicia positioning apparatus of claim 1, further comprising:
an indicia location calculator capable of determining an optimal indicia location given the dimensions of the workpiece to which indicia is to be etched; and
a controller capable of placing said laser device adjacent said optimal indicia location, said controller being further capable of instructing said laser device to operate.

3. The indicia positioning apparatus of claim 1, further comprising a workpiece conveyor adapted to move a workpiece linearly along on a plane, said conveyor disposed adjacent said x-track members, such that the laser device may be placed adjacent to and aimed perpendicularly to the plane of the workpiece conveyor.

4. The indicia positioning apparatus of claim 1, further comprising:
a first motor being in driving communication with said y-track member and capable of moving said y-track member along said first dimension;
a second motor being in driving communication with said shuttle and being capable of moving said shuttle along said second dimension.

5. A computerized method of imparting etched indicia to a planar workpiece, comprising the steps of:
providing a laser beam etcher capable of etching an image in the planar workpiece;
positioning said planar workpiece perpendicularly to the aim of said etcher;
calculating an optimal indicia location according to established parameters;
moving said laser beam etcher adjacent said optimal indicia location;
determining an optimal orientation for said image;
deriving orientation data from said optimal orientation;
transmitting said image data and said orientation data to said laser beam etcher; and
instructing said laser beam etcher to fire.

6. The computerized method of claim 5, wherein the orientation data and image data are transmitted to said laser beam etcher as separate data elements.

7. The computerized method of claim 5, wherein the orientation data is incorporated into said image data prior to transmission to said laser beam etcher.

8. A computerized method of imparting an indicia to a planar surface, comprising the steps of:
providing an etcher capable of etching an indicia in the planar workpiece media;
providing a subject of the planar workpiece media having a first edge and a second edge;
determining a desired indicia location on said workpiece, said location being at an intersection of a first and second inset line, the first and second inset lines being at an angle to each other, the first inset line being a specified distance from a first tangent line, said first tangent line being tangent to said first edge, said second inset line being a specified distance from a second tangent line, said second tangent line being tangent to said second edge, and said second tangent line being a specified distance from said second tangent line;
determining a first offset distance from the first edge at which the intersection should be located;
determining a second offset distance from the second edge at which the intersection should be located;
positioning said planar workpiece adjacent said etcher;
transmitting image data and orientation data to said etcher;
finding the first edge of said planar workpiece;
finding the second edge of said planar workpiece;
positioning said etcher adjacent the intersection;
imparting the indicia to the planar workpiece surface at the intersection.

9. The method of imparting an indicia of claim 8, where the step of positioning said etcher adjacent the intersection comprises the steps of:
positioning said etcher at a point along said first dimension, at a distance from the first edge equal to the first offset distance;
positioning said etcher at a point along said second dimension, at a distance from the second edge equal to the second offset distance.

10. A computerized method of indicia placement on a planar surface, comprising the steps of:
providing a workpiece having a planar surface;
providing an indicia image;
obtaining the dimensions of the planar surface;
inputting an approximate desired indicia location and a desired orientation;
calculating an optimal indicia location on the planar surface according to the desired indicia location;
effecting the movement of an indicia imparting device to the optimal indicia location on the planar surface relative; and
imparting the indicia at the optimal indicia location on the planar surface.

11. The computerized method of claim 10, where the step of imparting the indicia comprises the steps of placing a laser emitting device to be adjacent the planar surface and aimed perpendicularly to said surface, and emitting light from the laser in a pattern to impart the indicia image.

12. The computerized method of claim 9, where the step of emitting light from the laser in a pattern to impart the indicia is effected by a picture-imparting laser.

13. The computerized method of claim 10, where the step of emitting light from the laser in a pattern is effected according to a computerized image file.

14. A computerized method of imparting etched indicia to a planar workpiece, comprising the steps of:
providing an etcher capable of etching an indicia in a planar workpiece media according to orientation data received from a controller;
providing a subject of the planar workpiece media having a first edge and a second edge;
determining a desired indicia location on the workpiece, the location being at an intersection of a first and second dimension, the first and second dimensions a specified distance from the first edge and the second edge;
determining a first offset distance from the first edge at which the intersection should be located;
determining a second offset distance from the second edge at which the intersection should be located;
positioning the planar workpiece adjacent the etcher;
transmitting to the etcher indicia image data;
transmitting to the etcher indicia orientation data;
detecting the first edge of the planar workpiece;
detecting the second edge of the planar workpiece;
positioning the etcher adjacent the intersection; and
imparting the indicia to the planar workpiece surface at the intersection.

15. The method of claim 14, wherein the step of positioning the etcher adjacent the intersection comprises the steps of:
positioning the etcher at a point along the first dimension, at a distance from the first edge equal to the first offset distance;
positioning the etcher at a point along the second dimension, at a distance from the second edge equal to the second offset distance.

16. A computerized method of indicia placement on a planar surface, comprising the steps of:
providing a workpiece having a planar surface;
providing an indicia image;
obtaining the dimensions of the planar surface;
inputting an approximate desired indicia location and a desired orientation;
calculating an optimal indicia location on the planar surface according to the desired indicia location; and
imparting the indicia at the optimal indicia location on the planar surface.

17. The method of claim 16, wherein the step of imparting the indicia comprises the steps of:
placing a laser emitting device adjacent the planar surface; and
emitting light from the laser in a pattern to impart the indicia image.

18. The method of claim 17, wherein the step of imparting the indicia further comprises the step of transmitting orientation data to the laser emitting device.

19. The method of claim 17, wherein the step of emitting light from the laser in a pattern to impart the indicia is effected using a picture-imparting laser.

20. The method of claim 17, wherein the step of emitting light from the laser in a pattern is effected according to a computerized image file.

21. The method of claim 20, wherein the computerized image file has been modified to incorporate data regarding desired orientation.

22. The method of claim 16, wherein the step of imparting the indicia comprises the steps of:
placing a laser emitting device adjacent the planar surface;
transmitting orientation data to the laser emitting device; and
emitting light from the laser in a pattern to impart the indicia image.

23. The method of claim 16, further comprising the step of receiving the workpiece at a fixed position in a workstation.

24. The method of claim 16, wherein the indicia comprises logo information.

25. The method of claim 16, wherein the indicia comprises text information.

26. The method of claim 25, wherein the indicia comprises window specification information.

27. The method of claim 25, wherein the indicia comprises NFRC ratings.

28. The method of claim 26, further comprising the steps of:
determining window specification data by testing the workpiece; and
transmitting said window specification data to an indicia imparter.

29. The indicia positioning apparatus of claim 1, wherein said indicia positioning apparatus is incorporated into a workpiece processing line.

30. The indicia positioning apparatus of claim 29, wherein said workpiece processing line is a glass processing line.

31. The indicia positioning apparatus of claim 29, wherein said workpiece processing line is a processing line for insulated glass assembly units.

32. The indicia positioning apparatus of claim 1, wherein said x-track members and y-track members are all positioned horizontally.

33. The indicia positioning apparatus of claim 32, wherein said indicia positioning apparatus is disposed over a glass cutting table at a distance adapted to provide for etching of a workpiece placed on said cutting table.
